(19) United States
(12) Patent Application Publication
(10) Pub. No.: US 2019/0027173 A1
(43) Pub. Date: Jan. 24, 2019

(54) COMPOSITE HEAT ASSISTED MAGNETIC RECORDING MEDIA WITH ANISOTROPY FIELD AND CURIE TEMPERATURE GRADIENT

(71) Applicant: Seagate Technology LLC, Cupertino, CA (US)

(72) Inventors: YinFeng DING, Pleasanton, CA (US); Pin-Wei HUANG, Fremont, CA (US); Ganping JU, Pleasanton, CA (US); Yingguo PENG, San Ramon, CA (US); Li GAO, San Jose, CA (US); Timothy J. KLEMMER, Union City, CA (US); Kai-Chieh CHANG, Pleasanton, CA (US); Yukiko KUBOTA, Campbell, CA (US); Florin ZAVALICHE, San Ramon, CA (US); Xiaobin ZHU, San Ramon, CA (US); Qihong WU, Dublin, CA (US); Hassib AMINI, Fremont, CA (US); Jan-Ulrich THIELE, Sunnyvale, CA (US)

(21) Appl. No.: 15/654,562

(22) Filed: Jul. 19, 2017

(51) Int. Cl. G11B 5/65; G11B 5/66; G11B 5/84; G11B 5/02

(52) U.S. Cl. CPC G11B 5/65; G11B 5/66; G11B 2005/0021; G11B 5/02; G11B 5/84

(57) ABSTRACT

An apparatus is disclosed. The apparatus includes a first write layer, a second write layer, and a storage layer. The first write layer is disposed over the storage layer. The second write layer is disposed over the first write layer. The anisotropy field of the storage layer is greater than anisotropy field of the first write layer. The anisotropy field of the first write layer is greater than anisotropy field of the second write layer. The Curie temperature of the second write layer is greater than the Curie temperature of the first write layer. The Curie temperature of the first write layer is greater than a Curie temperature of the storage layer.

### SUMMARY

Provided herein is heat assisted magnetic recording (HAMR) media to store information. The apparatus includes a first write layer, a second write layer, and a storage layer. The first write layer is disposed over the storage layer. The second write layer is disposed over the first write layer. The anisotropy field of the storage layer is greater than anisotropy field of the first write layer. The anisotropy field of the first write layer is greater than anisotropy field of the second write layer. The Curie temperature of the second write layer is greater than the Curie temperature of the first write layer. The Curie temperature of the first write layer is greater than the Curie temperature of the storage layer.

These and other features and advantages will be apparent from a reading of the following detailed description.

### BRIEF DESCRIPTION OF DRAWINGS

FIGS. 1A-1E show a heat assisted magnetic recording (HAMR) media and performance thereof according to one aspect of the present embodiments.

FIGS. 2A-2J show the HAMR media that undergoes a write process according to one aspect of the present embodiments.

FIGS. 3A-3B show the HAMR media according to one aspect of the present embodiments.

FIG. 4 shows a flow diagram for a HAMR media that undergoes a write process according to one aspect of the present embodiments.

### DESCRIPTION

Before various embodiments are described in greater detail, it should be understood that the embodiments are not limiting, as elements in such embodiments may vary. It should likewise be understood that a particular embodiment described and/or illustrated herein has elements which may be readily separated from the particular embodiment and optionally combined with any of several other embodiments or substituted for elements in any of several other embodiments described herein.

It should also be understood that the terminology used herein is for the purpose of describing the certain concepts, and the terminology is not intended to be limiting. Unless defined otherwise, all technical and scientific terms used herein have the same meaning as commonly understood in the art to which the embodiments pertain.

Unless indicated otherwise, ordinal numbers (e.g., first, second, third, etc.) are used to distinguish or identify different elements or steps in a group of elements or steps, and do not supply a serial or numerical limitation on the elements or steps of the embodiments thereof. For example, “first,” “second,” and “third” elements or steps need not necessarily appear in that order, and the embodiments thereof need not necessarily be limited to three elements or steps. It should also be understood that, unless indicated otherwise, any labels such as “left,” “right,” “front,” “back,” “top,” “middle,” “bottom,” “beside,” “forward,” “reverse,” “overlying,” “underlying,” “up,” “down,” or other similar terms such as “upper,” “lower,” “above,” “below,” “under,” “between,” “over,” “vertical,” “horizontal,” “proximal,” “distal,” and the like are used for convenience and are not intended to imply, for example, any particular fixed location, orientation, or direction. Instead, such labels are used to reflect, for example, relative location, orientation, or directions. It should also be understood that the singular forms of “a,” “an,” and “the” include plural references unless the context clearly dictates otherwise.

It is understood heat assisted magnetic recording (HAMR) media may include both granular magnetic layers and continuous magnetic layers. Granular layers include grains that are segregated in order to physically and magnetically decouple the grains from one another. Segregation of the grains may be done, for example, with formation of oxides at the boundaries between adjacent magnetic grains. As such, the segregated magnetic grains form a granular layer. When multiple granular layers stacked together they form a columnar structure, where the magnetic alloys are hetero-epitaxially grown into columns while the oxides segregate into grain (column) boundaries. HAMR media may include both granular layers and continuous layers. In various embodiments, continuous layers include zero or much less segregation materials than found in the granular layers.

Information is written to the HAMR media at elevated temperatures close to the Curie temperature of the media. As the HAMR media is cooled down from the Curie temperature to the write temperature, e.g., 675 K, the anisotropy fields of the grains are still small enough such that grains under the write pole align with the magnetic field direction of the write pole. The grains are further cooled down to room temperature, e.g., 300 K, to permanently store information in the grains. Unfortunately, the storage layer used for HAMR media has a small magnetic moment and the Zeeman energy is insufficient to keep the grains from switching back to undesired states. Moreover, grains have variations, e.g., 3-5%, thus impacting the Curie temperature and the write temperature of the HAMR media that results in significant transition noise. Furthermore, even at lower temperatures, e.g., 550 K, grains with smaller volume are susceptible to erase after write and squeeze. Accordingly, a HAMR media with improved media recording performance and areal density is desired.

In some embodiments, a HAMR media includes a first write layer, a second write layer, and a storage layer. The first write layer is disposed over the storage layer. The second write layer is disposed over the first write layer. The anisotropy field of the storage layer is greater than anisotropy field of the first write layer. The anisotropy field of the first write layer is greater than anisotropy field of the second write layer. The Curie temperature of the second write layer is greater than the Curie temperature of the first write layer. The Curie temperature of the first write layer is greater than a Curie temperature of the storage layer. In other words, the HAMR media with anisotropy field gradient is formed with increasing anisotropy field from the uppermost write layer toward the bottommost storage layer. Moreover, the HAMR media with Curie temperature gradient is formed with decreasing Curie temperature from the uppermost write layer toward the bottommost storage layer.

Accordingly, magnetization of the uppermost write layer is oriented with the external magnetic field at writing temperature, e.g., lower than the layer's Curie temperature. Once the HAMR media cools down, the magnetization of subsequent layers is similarly oriented with the external magnetic field with assistance from previously oriented layers, e.g., uppermost write layer, etc., until the magnetization of the bottommost storage layer is oriented with the external magnetic field. In other words, the magnetization of each layer starting from the uppermost write layer has a cascading effect which assists the external magnetic field in orienting subsequent layers, e.g., subsequent write layers, subsequent storage layer(s), etc. The magnetization orientation of the storage layer, e.g., bottommost storage layer, is maintained once the HAMR media is cooled to the room temperature, e.g., 300 K.

It is appreciated that in some embodiments, a thermal exchange control layer (TECL) may be used, as described in patent application Ser. No. 15/466,798, which is incorporated herein by reference in its entirety. Coupling and decoupling between the storage layer and the write layer, using the thermal exchange control layer, during the heating and cooling process to write information in the storage layer, decouples the noise of the write layer from that of the storage layer, thereby reducing the overall noise once the HAMR media is returned to a temperature below the Curie temperature. It is appreciated that the Curie temperature of the thermal exchange control layer is lower than the Curie temperature of the storage layer which has a lower Curie temperature than the Curie temperature of the write layer. Thus, DC signal to noise ratio (SNR) and transition SNR are improved.

In some embodiments, the exchange coupled composite (ECC) of the HAMR media may be improved by inserting break layers between the write layers or a subset thereof. In some embodiments, the ECC of the HAMR media may be improved by inserting break layers between the storage layers or a subset thereof. According to some embodiments, the break layer may include nonmagnetic material. Furthermore, it is appreciated that the break layer may partially or completely couple and decouple the write layers and the storage layer during the heating process of writing information that is followed by the cooling process. Break layers may assist in further tuning the exchange coupling composite interaction between the write layers. In some embodiments, the break layer(s) may be weakly magnetic.

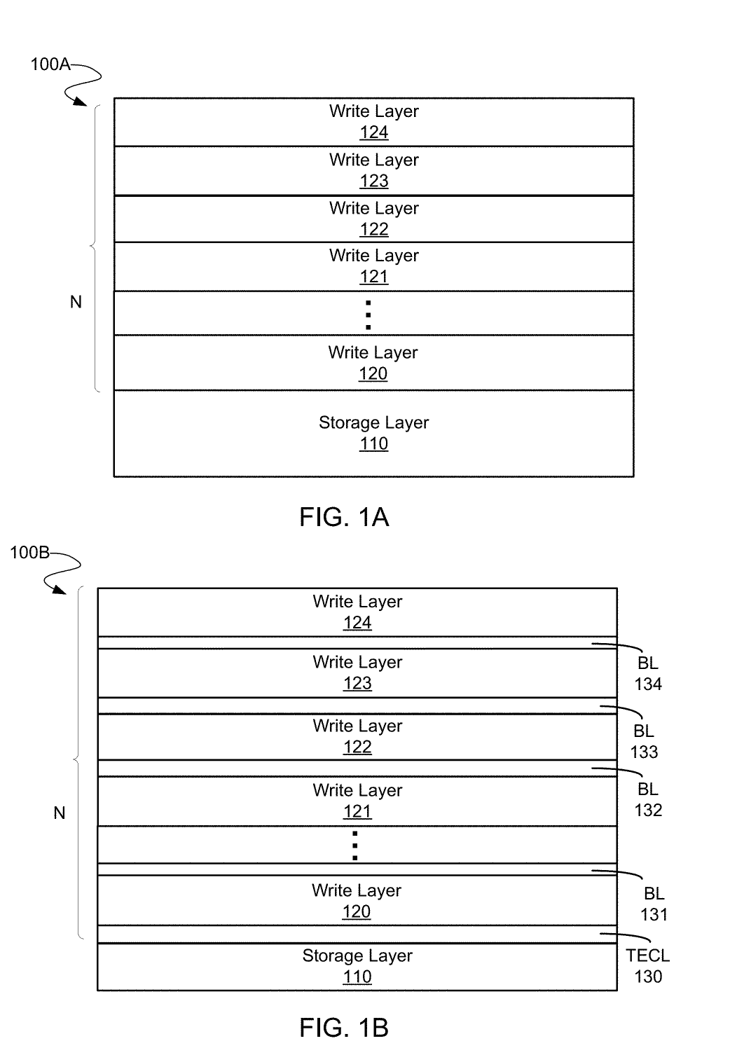

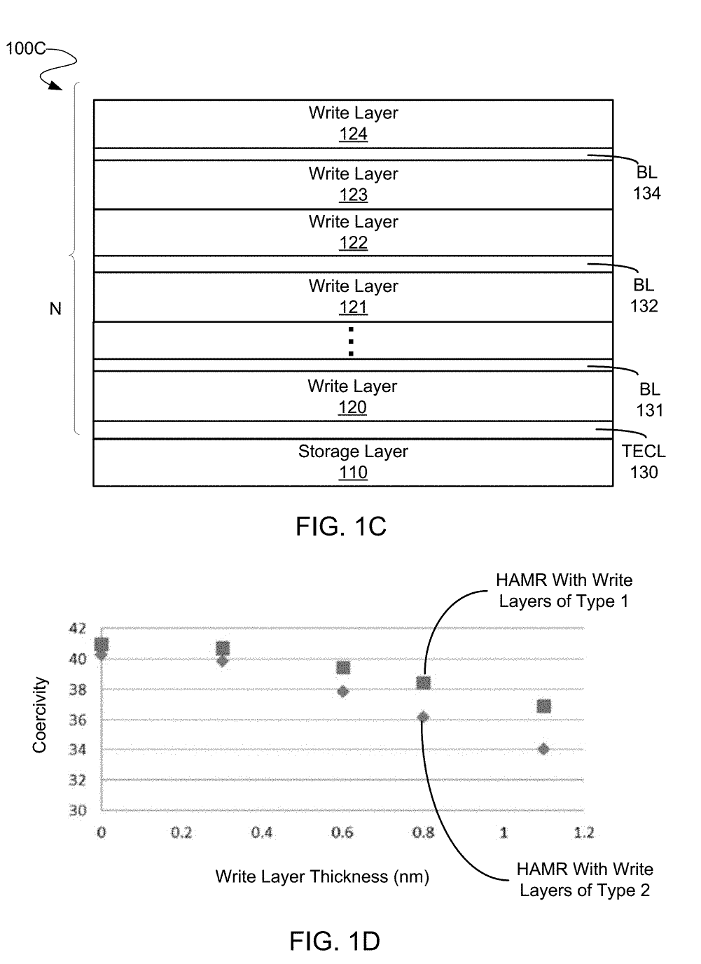

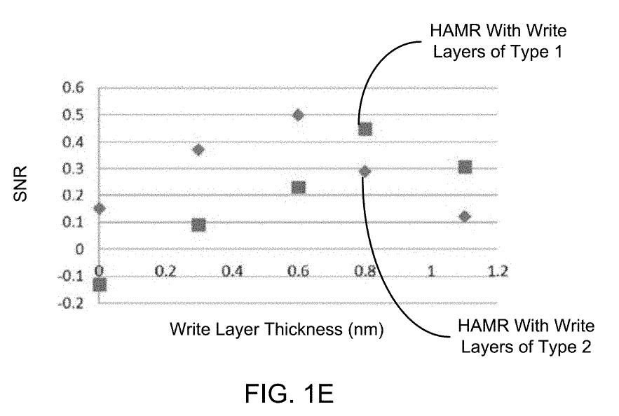

Referring now to FIG. 1A, a heat assisted magnetic recording (HAMR) media 100A according to one aspect of the present embodiments is shown. The HAMR media 100A includes a storage layer 110, e.g., FePt or an alloy thereof, and multiple write layers 120, . . . , 124 disposed over the storage layer 110. In this embodiment, N write layers are shown but it is appreciated that the number of write layers are for illustrative purposes only and should not be construed as limiting the scope of the embodiments. It is appreciated that the storage layer 110 may be a continuous layer or one or more granular layers. For example, the storage layer 110 may include grain decoupling material, e.g., C, Oxide such as B₂O₃, TaO₅, TiO₃, WO₃, SiO₂, Carbide such as SiC, BC, TiC, TaC, Nitride such as BN, SiN, TiN, etc., or any combination thereof.

According to some embodiments, each write layer, e.g., write layer 120, . . . , 124, may include material such as FePtX, FeCoPtX, FePdX, FeCoPdX, CoPtX, CoCrPtX, CoFePtX, CoCrX, FeCoX, or alloy thereof, etc. In some embodiments, the write layers include X is Ta, Mo, Si, Cu, Ag, Mn, Au, Ge, Hf, Zr, Ti, V, W, Fe, Ni, Oxide, Ru, Rh, Cr, B, BN, WO₃, Ta₂O₅, SiO₂, CrO₃, CoO, TiO, etc.

It is appreciated that the write layers 120, . . . , 124 may be a continuous layer or one or more granular layers. For example, the write layer 120 may include grain decoupling material, e.g., C, Oxide such as B₂O₃, TaO₅, TiO₃, WO₃, SiO₂, Carbide such as SiC, BC, TiC, TaC, Nitride such as BN, SiN, TiN, etc., or any combination thereof.

It is appreciated that the storage layer 110 and the write layer 120-124 form an anisotropy field gradient that increases in value from the write layers toward the storage layer. In other words, the anisotropy field of the storage layer 110 is greater than the anisotropy field of the write layer 120. The anisotropy field of the write layer 120 is greater than or equal to the anisotropy field of the write layer 121. The anisotropy field of the write layer 121 is greater than or equal to the anisotropy field of the write layer 122. The anisotropy field of the write layer 122 is greater than or equal to the anisotropy field of the write layer 123. The anisotropy field of the write layer 123 is greater than or equal to the anisotropy field of the write layer 124.

It is appreciated that the storage layer 110 and the write layer 120-124 form a Curie temperature gradient that decreases in value from the write layers toward the storage layer. In other words, the Curie temperature of the storage layer 110 is smaller than the Curie temperature of the write layer 120. The Curie temperature of the write layer 120 is less than the Curie temperature of the write layer 121. The Curie temperature of the write layer 121 is less than the Curie temperature of the write layer 122. The Curie temperature of the write layer 122 is less than the Curie temperature of the write layer 123. The Curie temperature of the write layer 123 is less than the Curie temperature of the write layer 124. It is appreciated that in a HAMR media where Fe and/or FePt is used, use of Co can increase the Curie temperature. As such, higher amount of Co may be used for upper write layers in comparison to the lower write layers and the storage layer. Other similar components or compositions may be used to create the gradient, as described above.

It is appreciated that in order to form the anisotropy field and the Curie temperature gradient, as described above, the write layers have different compositions. For example, in some embodiments, the write layer 120 is different from the write layer 122, the write layer 120 is different from write layer 121 which are both different from the write layer 122, etc.

It is appreciated that in some embodiments, the storage layer 110 and the write layer 120-124 may also form magnetization gradient that decreases in value from the write layers toward the storage layer. In other words, magnetization of the storage layer 110 is smaller than the magnetization of the write layer 120. The magnetization of the write layer 120 is less than the magnetization of the write layer 121. The magnetization of the write layer 121 is less than the magnetization of the write layer 122. The magnetization of the write layer 122 is less than the magnetization of the write layer 123. The magnetization of the write layer 123 is less than the magnetization of the write layer 124.

When the media starts cooling down the stability and the alignment of the magnetization of the write layers and the storage layer are maintained until the freezing temperature (temperature at which the magnetization of the storage layer cannot be switched by the external magnetic field) is reached. It is appreciated that the magnetic orientation of the write layers and the magnetic orientation of the storage layer is maintained at freezing temperature, therefore retaining (storing) information therein.

It is appreciated that a thickness of the storage layer 110 may range between 1-15 nm. (inclusive). In some embodiments, a thickness of each write layer, e.g., write layer 124, write layer 123, . . . , write layer 120, may range from 0.1-5 nm (inclusive). It is appreciated that the write layers may have different thicknesses from one another. For example, a thickness of the write layer 124 may be different from the thickness of the write layer 123, etc.

Referring now to FIG. 1B, a HAMR media 100B in accordance with one aspect of the present embodiments is shown. The HAMR media 100B is substantially similar to that of FIG. 1A. In embodiment 100B, the write layers 120, . . . , 124 are separated from one another as well as the storage layer 110 using break layers 131, 132, 133, and 134. The write layer 120 may be separate from other write layers via the break layer 131. Similarly, the write layer 121 may be separated from the write layer 122 via the break layer 132, etc.

It is appreciated that the break layers may be nonmagnetic according to some embodiments. For example, the break layers 131, . . . , 134 may include FeX, wherein X is Co, Cr, Oxide, Nitride, C, B, etc., and where the composition of X is selected such that FeX is nonmagnetic. In some embodiments, the break layers may include FeCoX where X is Cr, Oxide, Nitride, C, B, etc., where the composition of X is selected such that FeCoX is nonmagnetic. The break layers 131, . . . , 134 may further tune the ECC interaction between the write layers, e.g., write layer 120, . . . , 124. In some embodiments, the break layers and variation in their thickness, composition, growing condition, etc., may affect the intensity and/or directionality of the exchange interaction among the write layers that are magnetic, providing extra degrees of freedom for the ECC interaction.

It is appreciated that the break layers 131, . . . , 134 may be continuous layer or one or more granular layers. For example, the break layers 130, . . . , 134 may include grain decoupling material, e.g., C, carbide such as SiC, BC, TiC, TaC, etc., nitride such as BN, SiN, TiN, TaN, etc., oxide such as SiO₂, B₂O₃, Ta₂O₅, TiO₂, WO₃, TaO₅, TiO₃, etc., or any combination thereof. According to some embodiments, the break layers 131, . . . , 134 maintain the granular structures, magnetization orientation and anisotropy between the storage layer 110 to the write layers 120, . . . , 124.

It is appreciated that in some embodiments, the HAMR media 100B further includes a thermal exchange control layer (TECL) 130. TECL 130 may be disposed between the bottommost write layer 120 and the uppermost storage layer 110. The Curie temperature of the TECL 130 is lower than the write layer 124. In fact, the TECL 130 may have a Curie temperature that is lower than all of the write layers 120-124 as well as the storage layer 110. TECL 130 partially turns the vertical exchange coupling between the write layer 120 and the storage layer 110 on and off during write process and cooling, wherein the partial turn on and off by the thermal exchange control layer suppresses noise. TECL may be substantially similar to the TECL described in patent application number 15/466,798 that is incorporated herein by reference in its entirety.

It is appreciated that in some embodiments, instead of using TECL 130 a break layer similar to break layers 131, . . . , 134 may be used. In some embodiments, no break layer and no thermal exchange control layer is used. Furthermore, it is appreciated that the use of the TECL 130 and/or break layers 131, . . . , 134 in the specific position within the HAMR media is exemplary and not intended to limit the scope of the embodiments. For example, the TECL 130 may be positioned between two write layers or it may be positioned between two storage layers. Moreover, a break layer may be positioned between the bottommost write layer and the uppermost storage layer. As such, use of the break layers and/or the thermal exchange control layer, as described, is for illustrative purposes and is not intended to limit the scope of the embodiments.

Referring now to FIG. 1C, a HAMR media 100C in accordance with one aspect of the present embodiments is shown. The HAMR media 100C is substantially similar to that of FIG. 1B except that there is not necessarily a one to one correspondence between the write layers and the break layers. For example, the write layer 123 may be in direct contact with the write layer 122 without any break layers in between. It is appreciated that the number of break layers shown and their position between the write layers is for illustrative purposes and not intended to limit the scope of the embodiments. For example, in some embodiments, the write layer 120 may be in direct contact with other write layers, e.g., write layer 121, without any break layers in between, e.g., without break layer 131.

Referring now to FIG. 1D, dependence of coercivity for a HAMR media on thickness of an additional write layer in accordance with one embodiment is shown. HAMR media with write layers of type 1 shows that coercivity decreases in more of a linear fashion as the thickness of the write layer is increased. On the other hand, HAMR media with write layers of type 2 (with lower anisotropy field than type 1) shows that the coercivity decreases more rapidly after a certain thickness as the thickness of the write layer is increased. In this example, thickness of all write layers 120-123 may be fixed and thickness of the write layer 124 may be varied from 0 to 1.2 nm. As shown, as the thickness of the write layer 124 of type 2 increases the coercivity is decreased by a small amount until the thickness of the write layer 124 reaches 0.6 nm at which point the coercivity is substantially decreases due to lower anisotropy field of the write layer 124 in comparison to other write layers 120-123 and the storage layer 110. Similarly, as shown, as the thickness of the write layer 124 of type 1 increases the coercivity decreases by a small amount and more in a linear fashion due to lower anisotropy field of the write layer 124 in comparison to other write layers 120-123 and the storage layer 110. It is appreciated that varying the thickness of other write layers are substantially similar to the one shown in FIG. 1D. It is appreciated that as shown, both types of HAMR media with write layers show coercivity decreasing as the write layer thickness increases.

Referring now to FIG. 1E, variation of the squeeze SNR (recording track SNR in the presence of adjacent Squeeze tracks) by varying the thickness of a write layer in accordance with one embodiment is shown. For example, thickness of all write layers 120-123 may be fixed and thickness of the write layer 124 may be varied from 0 to 1.2 nm. As shown, the squeeze SNR for both types of write layers for the HAMR media is improved as the write layer thickness varies from 0 to approximately 0.6-0.8 nm, at which point the SNR decreases. It is appreciated that both types of HAMR media with write layers show similar behavior as the squeeze SNR improves until a certain threshold thickness for the write layer and after which the SNR decreases. The additional SNR gain at certain thickness of this additional write layer (124) shows the benefit of the composite media design, which will be able support higher recording density.

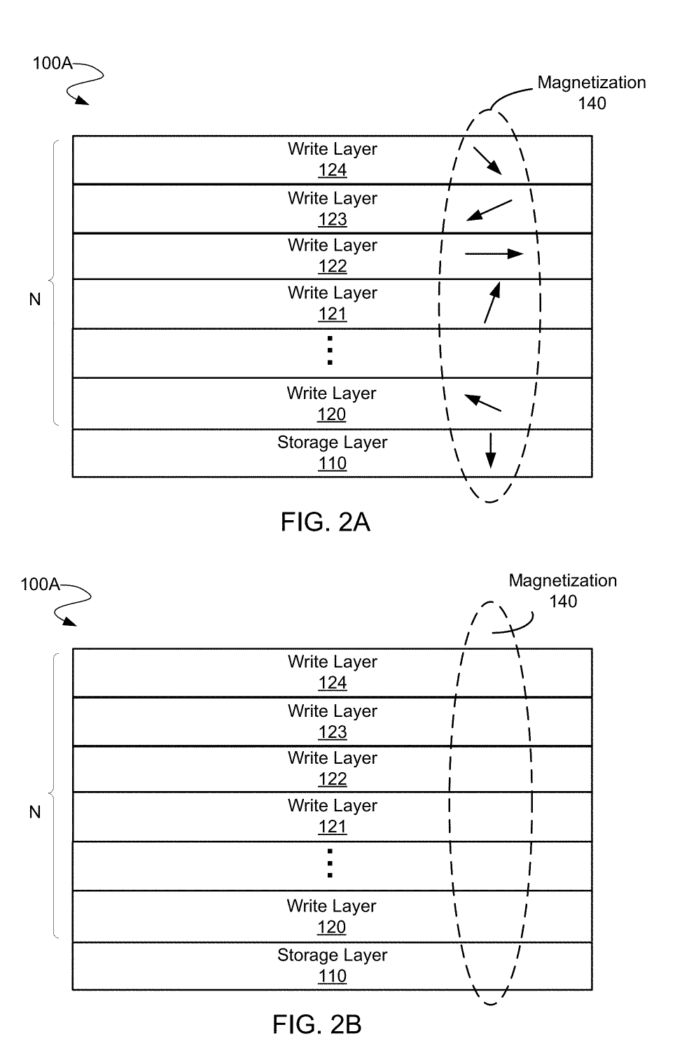

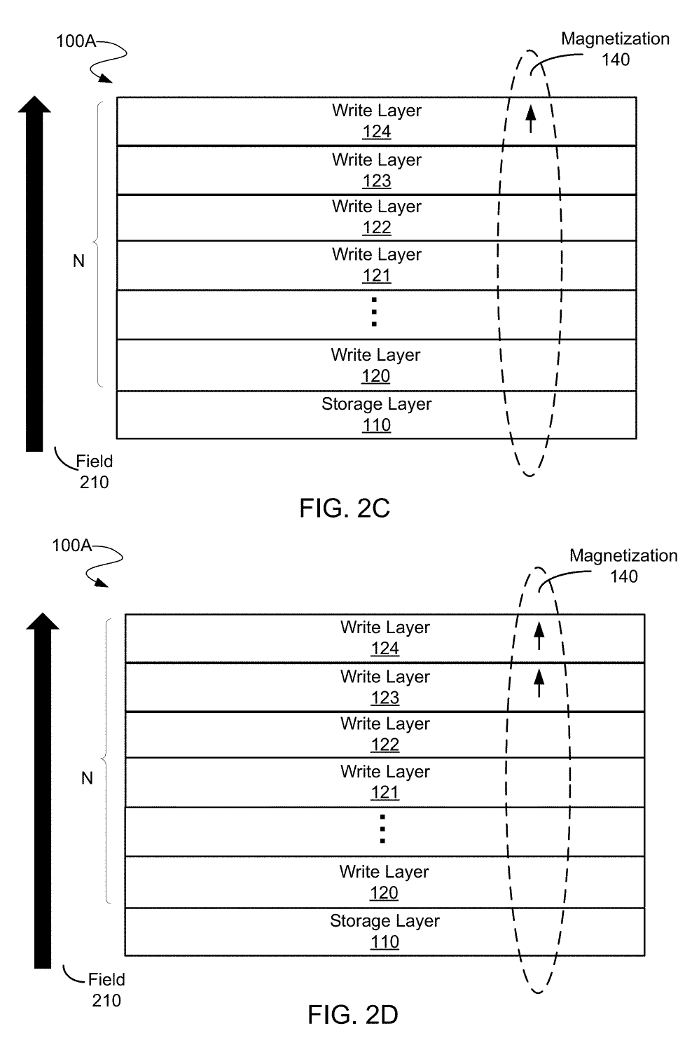

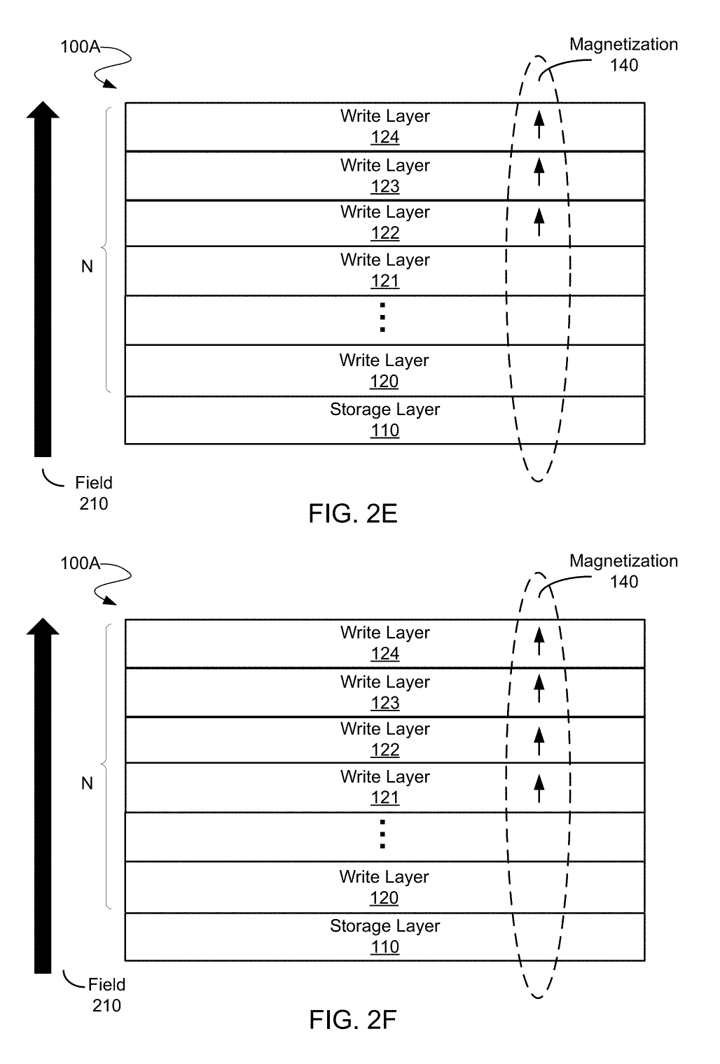

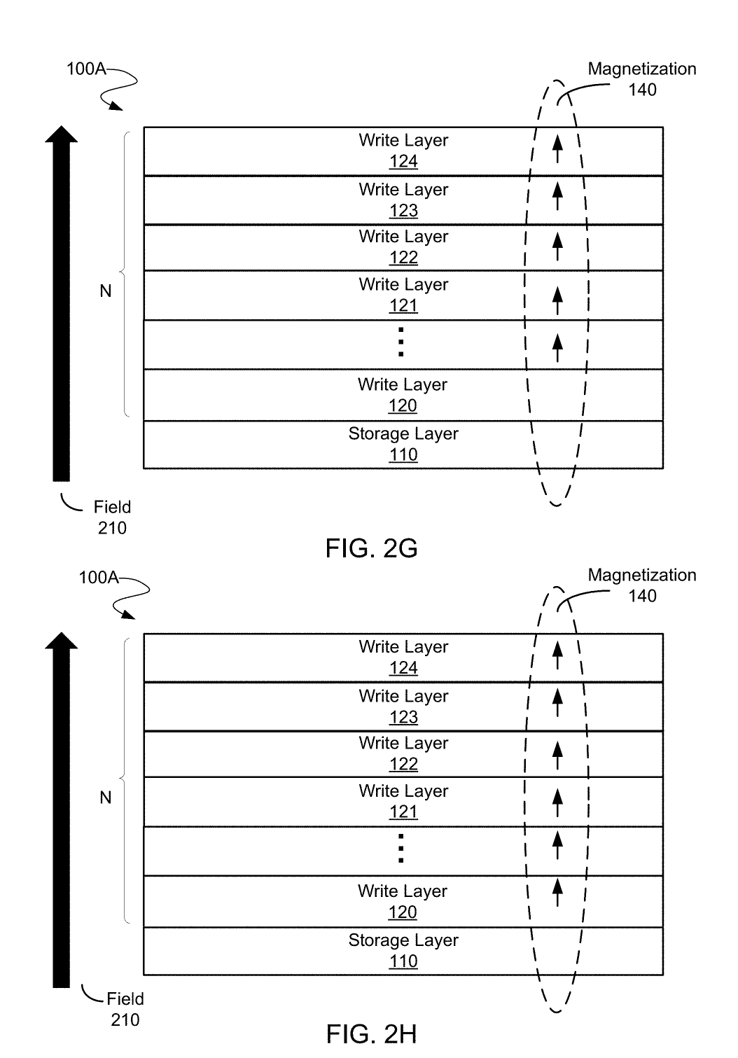

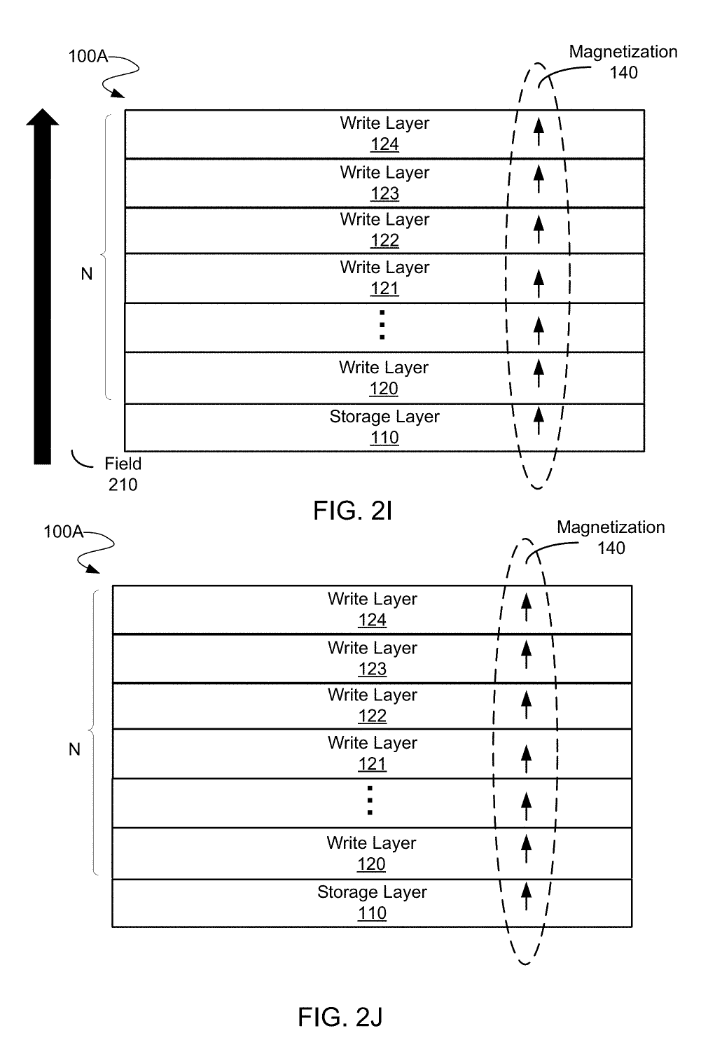

FIGS. 2A-2J show the HAMR media 100A that undergoes a write process according to one aspect of the present embodiments. FIG. 2A depicts a state prior to the HAMR write process. As such, each layer may have a magnetization orientation 140 of its own or it may be aligned due to exchange coupling between any two layers. It is appreciated that FIG. 2A may be directed to a period prior to the current HAMR write process but it may be directed to a previously write HAMR process. It is appreciated that if the HAMR media 100A has been written to in the past, then the magnetization orientations 140 may be more aligned with one another, e.g., all substantially face down, all substantially face up, etc.

Referring now to FIG. 2B, the HAMR media 100A is heated above the highest Curie temperature, e.g., 700 K, between the write layers 120, . . . , 124 and the storage layer 110. Accordingly, the magnetization orientation of the write layers 120, . . . , 124 and the storage layer 110 is substantially removed. In other words, the write layers 120, . . . , 124 and the storage layer 110 become non-magnetic at or above the highest Curie temperature among the layers.

Referring now to FIG. 2C, the HAMR media 100A is cooling off the highest Curie temperature between the write layers 120, . . . , 124 and the storage layer 110. In other words, the temperature is at the writing temperature (below the Curie temperature), e.g., 675 K. Moreover, the external magnetic field 210 is applied. Due to the gradient of the anisotropy field and the Curie temperature in the write layers 120-124 and the storage layer 110, at write temperature, the magnetic field orientation 140 of the write layer 124 aligns with the orientation of the external magnetic field 210. It is appreciated that magnetic orientation of other write layers do not align at this stage because the write layers 120-123 and the storage layer 110 have a lower Curie temperature and higher anisotropy field than the write layer 124.

Referring now to FIG. 2D, the HAMR media 100A is further cooling down and the magnetic field orientation of the write layer 124 in addition to the external magnetic field 210 causes the magnetic field orientation 140 of the write layer 123 to align with the external magnetic field 210. It is appreciated that other write layers 120-122 and the storage layer 110 do not align at this stage because the write layers 120-122 and the storage layer 110 have a lower Curie temperature and higher anisotropy field than the write layer 123.

This process repeats itself and cascades its way through the remaining write layers 120-122 and the storage layer 110. For example, referring now to FIG. 2E, the HAMR media 100A is further cooling down and the magnetic field orientation of the write layers 123 and 124 in addition to the external magnetic field 210 cause the magnetic field orientation 140 of the write layer 122 to align with the external magnetic field 210. It is appreciated that other write layers 120-121 and the storage layer 110 do not align at this stage because the write layers 120-121 and the storage layer 110 have a lower Curie temperature and higher anisotropy field than the write layer 122.

Referring now to FIG. 2F, the HAMR media 100A is further cooling down and the magnetic field orientation of the write layers 122, 123 and 124 in addition to the external magnetic field 210 cause the magnetic field orientation 140 of the write layer 121 to align with the external magnetic field 210. It is appreciated that other write layer 120 and the storage layer 110 do not align at this stage because the write layer 120 and the storage layer 110 have a lower Curie temperature and higher anisotropy field than the write layer 121.

Referring now to FIG. 2G, the HAMR media 100A is further cooling down and the magnetic field orientation of the write layers 121, 122, 123 and 124 in addition to the external magnetic field 210 cause the magnetic field orientation 140 of other write layers between the write layer 120 and the write layer 121 to align with the external magnetic field 210. It is appreciated that the write layer 120 and the storage layer 110 do not align at this stage because the write layer 120 and the storage layer 110 have a lower Curie temperature and higher anisotropy field than the write layers that are between the write layers 120 and 121.

Referring now to FIG. 2H, the HAMR media 100A is further cooling down and the magnetic field orientation of the write layers 121, 122, 123 and 124 in addition to the external magnetic field 210 cause the magnetic field orientation 140 of the write layer 120 to align with the external magnetic field 210. It is appreciated that the storage layer 110 does not align at this stage because the storage layer 110 has a lower Curie temperature and higher anisotropy field than the write layer 120.

Referring now to FIG. 2I, the HAMR media 100A is further cooling down and the magnetic field orientation of the write layers 120, 121, 122, 123 and 124 in addition to the external magnetic field 210 cause the magnetic field orientation 140 of the storage layer 110 to align with the external magnetic field 210. In other words, the anisotropy field and the Curie temperature gradient, as described above, enable the write layers 120-124 to have a cascading effect and assist the external magnetic field being applied in orienting the magnetization of the storage layer 110. At this stage, the media has cooled off to the freezing temperature, which may be room temperature in some embodiments, e.g., 300 K, and as such, once the external magnetic field 210 is removed, the magnetization orientation of the write layers 120, . . . , 124 and the storage layer 110 is maintained as shown in FIG. 2J.

It is appreciated that FIG. 2A-2J describe the writing process for the HAMR media 100A. It is appreciated that a similar process occurs for other HAMR media embodiments, e.g., HAMR media 100B and HAMR media 100C. As such, illustration of the writing process for the HAMR media 100A is for illustrative purposes and not intended to limit the scope of the embodiments.

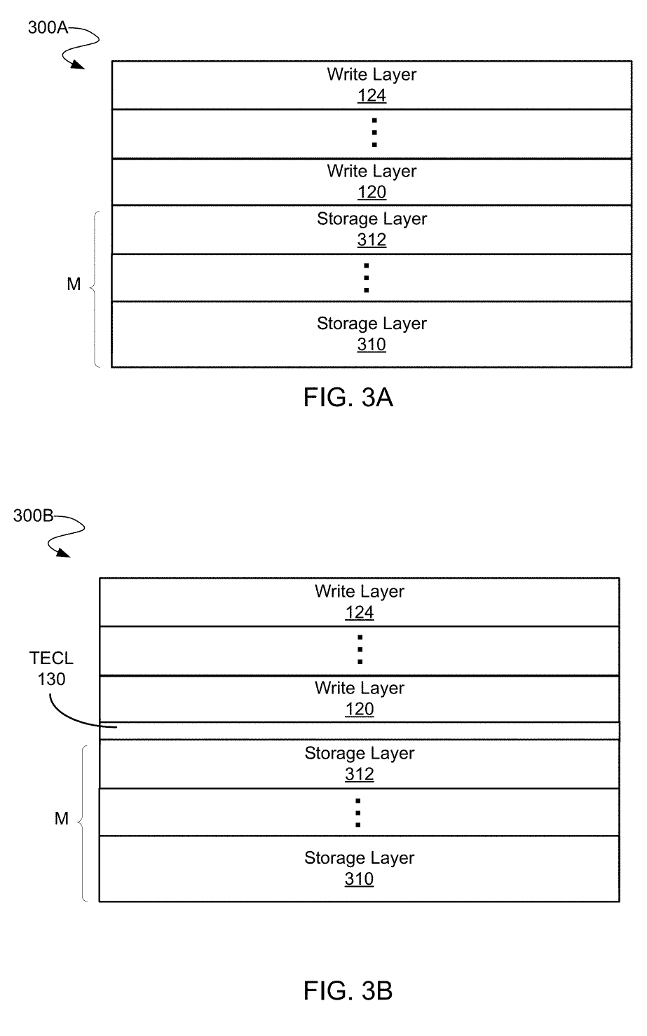

FIGS. 3A-3B show the HAMR media according to one aspect of the present embodiments. The HAMR media 300A is similar to that of FIG. 1A except that the storage layer is multiple storage layers, e.g., storage layers 310-312. The HAMR media 300A operates substantially similar to that of FIG. 1A and 2A-2J.

The HAMR media 300A includes storage layer 310-312, e.g., FePt or an alloy thereof. For example, the storage layer 310 may be FePtX and the storage layer 312 may be FePtY, where X and Y is Cu, Ag, Ni, Ru, Rh, or Mn and where X is different from Y or that the ratio of the composition is different if the storage layers all contain the same components. For example, the storage layer 310-312 may include FePt where Fe ranges between 40-65% and Pt ranges between 35-60%. In this embodiment, M storage layers are shown but it is appreciated that the number of storage layers are for illustrative purposes only and should not be construed as limiting the scope of the embodiments. It is appreciated that the storage layers 310-312 may be a continuous layer or one or more granular layers, as described with respect to FIGS. 1A-1C. For example, the storage layers 310-312 may include grain decoupling material, e.g., C, Oxide such as B₂O₃, TaO₅, TiO₃, WO₃, SiO₂, Carbide such as SiC, BC, TiC, TaC, Nitride such as BN, SiN, TiN, etc., or any combination thereof.

It is appreciated that the storage layers 310-312 and the write layer 120-124 form an anisotropy field gradient that increases in value from the write layers toward the storage layers. In other words, the anisotropy field of the storage layer 310 is greater than the anisotropy field of the storage layer 312. Moreover, the anisotropy field of the storage layer 312 is greater than the anisotropy field of the write layer 120. The anisotropy field of the write layer 120 is greater than or equal to the anisotropy field of other write layers, e.g., write layer 124, as described above in FIGS. 1A-1C and 2A-2J.

It is appreciated that the storage layers 310-312 and the write layer 120-124 form a Curie temperature gradient that decreases in value from the write layers toward the storage layers. In other words, the Curie temperature of the storage layer 310 is smaller than the Curie temperature of the storage layer 312. Similarly, the Curie temperature of the storage layer 312 is smaller than the Curie temperature of the write layer 120. The Curie temperature of the write layer 120 is less than the Curie temperature of other write layers, e.g., write layer 124, as described above in FIGS. 1A-1C and 2A-2J. It is appreciated that the thickness of the storage layers 310-312 is between 1-15 nm (inclusive).

Because of the anisotropy field gradient and the Curie temperature gradient that is formed using the write layers 120-124 and the storage layers 310-312, each layer assists the external magnetic field to orient the magnetic field of the remaining layers, as described above. For example, the magnetic fields of the write layers 120-124 are oriented as described in FIGS. 2A-2H. This process repeats itself and cascades its way through the storage layers 310-312. For example, the HAMR media 300A further cools down and the magnetic field orientation of the write layers 120-124 in addition to the external magnetic field 210 cause the magnetic field orientation 140 of the storage layer 312 to align with the external magnetic field 210. It is appreciated that other storage layers, e.g., storage layer 310, do not align at this stage because the write layers 120-124 and the storage layer 312 have a lower Curie temperature and higher anisotropy field than the remaining storage layers, e.g., storage layer 310. However, as the HAMR media 300A further cools, the magnetic field orientation of the remaining storage layers, e.g., storage layer 310, is oriented because the previously oriented layers, e.g., write layers 120-124 and the storage layer 312, assist the external magnetic field to orient the magnetic field of the remaining storage layers. This process repeats itself until the magnetic field of all layers of the HAMR media 300A is oriented and until the HAMR media 300A is cooled sufficiently, e.g., 300 K, to maintain the magnetization orientation.

When the media starts cooling down the stability and the alignment of the magnetization of the write layers and the storage layer are maintained until the freezing temperature (temperature at which the magnetization of the storage layer cannot be switched by the external magnetic field) is reached. The write layers may be chosen from material such that their magnetic properties remain substantially the same at writing temperature of the storage layer 110 therefore achieving substantial anisotropy field and magnetization variation in the system. It is appreciated that the magnetic orientation of the write layers and the magnetic orientation of the storage layer is maintained at freezing temperature, therefore retaining (storing) information therein.

Referring now to FIG. 3B, a HAMR media 300B in accordance with one aspect of the present embodiments is shown. The HAMR media 300B is substantially similar to that of FIG. 3A. In embodiment 300B, the storage layers 310, . . . , 312 are separated from the write layers 120-124 using a TECL 130. It is appreciated that a break layer may be used instead. The TECL 130 is substantially similar to the TECL described in FIGS. 1B and 1C and U.S. patent application Ser. No. 15/466,798, which is incorporated herein by reference in its entirety.

It is appreciated that any two layers, e.g., any two write layers, any two storage layers, any write layer and storage layer, may be separated from one another using a break layer, as described in FIGS. 1B and 1C. For example, the storage layer 312 may be separated from the storage layer 310 via the break layer. Moreover, the write layer 124 may be separate from other write layers, e.g., write layer 120, via a break layer. It is further appreciated that in some embodiments, while some layers may be separated from one another using a break layer, other layers may be in direct contact with one another without any break layer there between.

It is appreciated that the break layers may be nonmagnetic according to some embodiments. For example, the break layers may include FeX, wherein X is Co, Cr, Oxide, Nitride, C, B, etc., and where the composition of X is selected such that FeX is nonmagnetic. In some embodiments, the break layers may include FeCoX where X is Cr, Oxide, Nitride, C, B, etc., where the composition of X is selected such that FeCoX is nonmagnetic. The break layers may further tune the ECC interaction between the storage layers, e.g., storage layer 310, . . . , 312. In some embodiments, the break layers and variation in their thickness, composition, growing condition, etc., may affect the intensity and/or directionality of the exchange interaction among the write layers that are magnetic, providing extra degrees of freedom for the ECC interaction.

It is appreciated that the break layers may be continuous layers or one or more granular layers. For example, the break layers may include grain decoupling material, e.g., C, carbide such as SiC, BC, TiC, TaC, etc., nitride such as BN, SiN, TiN, TaN, etc., oxide such as SiO₂, B₂O₃, Ta₂O₅, TiO₂, WO₃, TaO₅, TiO₃, etc., or any combination thereof. According to some embodiments, the break layers maintain the granular structures, magnetization orientation and anisotropy between the storage layers 310-312 to the write layers 120-124.

It is appreciated that each break layer may have a different composition and/or thickness than other break layers. In some embodiments, at least two break layers have a different composition from one another. In some embodiments, at least two break layers have a different thickness from one another.

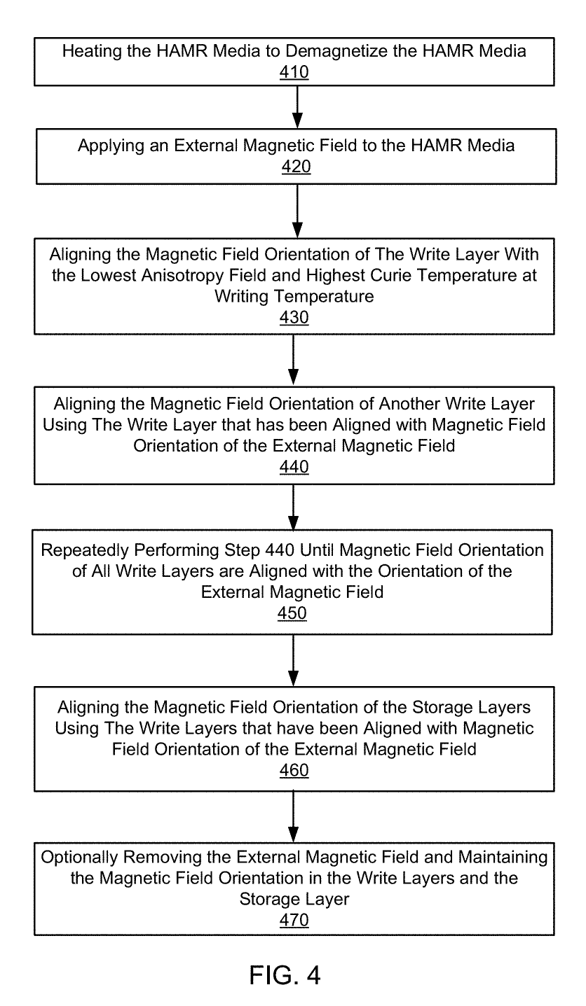

Referring now to FIG. 4, a flow diagram for a HAMR media that undergoes a write process according to one aspect of the present embodiments is shown. At step 410, the layers of the HAMR media are at least partially or completely demagnetized by heating the HAMR media. For example, the storage layer, the break layers, and the write layers may be heated to the Curie temperature of the layer with the highest Curie temperature in order to be substantially demagnetized. At step 420, as the media is cooling off (writing temperature), an external magnetic field is applied to the HAMR media. At step 430, the magnetic orientation of the write layer of HAMR media with the lowest anisotropy field and the highest Curie temperature (e.g., top write layer 124), at writing temperature, is aligned with that of the external magnetic field. At step 440, the magnetic field orientation of another write layer, e.g., write layer 123, is aligned with that of the external magnetic field using the already aligned magnetic field orientation of the write layer with the lowest anisotropy field and the highest Curie temperature, e.g., write layer 124, at writing temperature. Thus, the magnetic field orientation of the write layer 124 assists the external magnetic field to orient the magnetic field orientation of the write layer 123 to align with that of the external magnetic field. In other words, the alignment of the magnetic field orientation of the write layer 124 with that of the external magnetic field has a cascading effect on the magnetic field orientation of subsequent write layers, e.g., write layer 123, due to anisotropy field and Curie temperature gradient.

At step 450, the process is repeated for other write layers. In other words, other write layers are similarly aligned with the external magnetic field using previously aligned write layers. The previously aligned write layers assist the external magnetic field to orient the magnetic orientation of other write layers that have a higher anisotropy field and lower Curie temperature. The process is repeated until at step 460, the magnetic field orientation of the storage layers are aligned with that of the write layers and the external magnetic field. It is appreciated that the storage layers also have anisotropy field gradient and Curie temperature gradient similar to that of the writing layers. In other words, the upper storage layers, closer to the writing layers, have a smaller anisotropy field and higher Curie temperature in comparison to the lower storage layers. At freezing temperature, the apparatus is stable enough that the magnetic field orientation of the storage layer will not change in absence of the external magnetic field. As such, at step 470, the external magnetic field may be removed and the magnetic field orientation of the write layers and the storage layer may be maintained.

Accordingly, the gradient for the anisotropy field and Curie temperature of the write layers and the storage layers enables the write layer with lower anisotropy field and higher Curie temperature to pin other write layers and storage layers, with higher anisotropy field and lower Curie temperature, in presence of external magnetic field. The pinned write layers may subsequently pin other layers until the magnetic orientation of the storage layers is aligned with that of the external magnetic field. Because the apparatus has cooled off enough to reach the freezing temperature, the magnetic orientations of the write layers and the storage layer are maintained in absence of the external magnetic field. Accordingly, a HAMR media with improved media recording performance and areal density is provided. Moreover, DC signal to noise ratio (SNR) and transition SNR is improved.

While the embodiments have been described and/or illustrated by means of particular examples, and while these embodiments and/or examples have been described in considerable detail, it is not the intention of the Applicants to restrict or in any way limit the scope of the embodiments to such detail. Additional adaptations and/or modifications of the embodiments may readily appear to persons having ordinary skill in the art to which the embodiments pertain, and, in its broader aspects, the embodiments may encompass these adaptations and/or modifications. Accordingly, departures may be made from the foregoing embodiments and/or examples without departing from the scope of the concepts described herein. The implementations described above and other implementations are within the scope of the following claims.

What is claimed is:

1. An apparatus comprising:
a storage layer;
a first write layer disposed over the storage layer; and
a second write layer disposed over the first write layer,
wherein an anisotropy field of the storage layer is greater than an anisotropy field of the first write layer and wherein the anisotropy field of the first write layer is greater than an anisotropy field of the second write layer,
wherein a Curie temperature of the second write layer is greater than a Curie temperature of the first write layer, and wherein the Curie temperature of the first write layer is greater than a Curie temperature of the storage layer.

2. The apparatus of claim 1, wherein a material of the storage layer includes FePt.

3. The apparatus of claim 1, wherein a material of the first write layer is selected from a group consisting of FePtX, FeCoPtY, FePdX, FeCoPdY, CoPtZ, CoCrPtXX, and FeCoYY wherein X, Y, Z, XX, and YY is selected from a group consisting of Cu, Ag, Ni, Ru, Rh, and Mn and wherein a material of the second write layer is selected from a group consisting of FePtX, FeCoPtY, FePdX, FeCoPdY, CoPtZ, CoCrPtXX, and FeCoYY wherein X, Y, Z, XX, and YY is selected from a group consisting of Cu, Ag, Ni, Ru, Rh, and Mn.

4. The apparatus of claim 3, wherein the first write layer comprises grain decoupling material selected from a group consisting of C, B₂O₃, TaO₅, TiO₃, WO₃, SiO₂, SiC, BC, TiC, TaC, BN, SiN, TiN.

5. The apparatus of claim 1, wherein a thickness of the storage layer ranges from 1-15 nm, and wherein a thickness of the first write layer ranges from 0.1 to 5 nm, and wherein a thickness of the second write layer ranges from 0.1 to 5 nm.

6. The apparatus of claim 1 further comprising a thermal exchange control layer disposed between the first write layer and the storage layer, wherein a Curie temperature of the thermal exchange control layer is lower than the second write layer, wherein the thermal exchange control layer partially turns the vertical exchange coupling between the first write layer and the storage layer on and off during a write process and cooling, wherein the partial turn on and off by the thermal exchange control layer suppresses noise.

7. The apparatus of claim 1, wherein a magnetization of the second write layer aligns with an external magnetic field at a writing temperature of the second write layer, wherein a magnetization of the first write layer aligns with the external magnetic field at a writing temperature of the first write layer, and wherein a magnetization of the storage layer aligns with the external magnetic field subsequent to the second write layer and the first write layer aligning with the external magnetic field.

8. An apparatus comprising:
a first storage layer;
a second storage layer over the first storage layer;
a first write layer disposed over the second storage layer; and
a second write layer disposed over the first write layer,
wherein an anisotropy field of the first storage layer is greater than an anisotropy field of the second storage layer, and wherein the anisotropy field of the second storage layer is greater than an anisotropy field of the first write layer, and wherein the anisotropy field of the first write layer is greater than an anisotropy field of the second write layer,
wherein a Curie temperature of the second write layer is greater than a Curie temperature of the first write layer, and wherein the Curie temperature of the first write layer is greater than a Curie temperature of the second storage layer, and wherein the Curie temperature of the second storage layer is greater than a Curie temperature of the first storage layer.

9. The apparatus of claim 8, wherein a material of the first storage layer includes FePtX and a material of the second storage layer includes FePtY, wherein X is different from Y, and wherein X is selected from a group consisting of Cu, Ag, Ni, Ru, Rh, and Mn and wherein Y is selected from a group consisting of Cu, Ag, Ni, Ru, Rh, and Mn.

10. The apparatus of claim 8, wherein a material of the first write layer is selected from a group consisting of FePtX, FeCoPtY, FePdX, FeCoPdY, CoPtZ, CoCrPtXX, and FeCoYY wherein X, Y, Z, XX, and YY is selected from a group consisting of Cu, Ag, Ni, Ru, Rh, and Mn and wherein a material of the second write layer is selected from a group consisting of FePtX, FeCoPtY, FePdX, FeCoPdY, CoPtZ, CoCrPtXX, and FeCoYY wherein X is selected from a group consisting of Cu, Ag, Ni, Ru, Rh and Mn.

11. The apparatus of claim 10, wherein the first write layer comprises grain decoupling material selected from a group consisting of C, B₂O₃, TaO₅, TiO₃, WO₃, SiO₂, SiC, BC, TiC, TaC, BN, SiN, TiN.

12. The apparatus of claim 8, wherein a thickness of the first storage layer ranges from 2-15 nm and wherein a thickness of the second storage layer ranges from 1-15 nm, and wherein a thickness of the first write layer ranges from 0.1 to 5 nm, and wherein a thickness of the second write layer ranges from 0.1 to 5 nm.

13. The apparatus of claim 8 further comprising a thermal exchange control layer disposed between the first write layer and the second storage layer, wherein a Curie temperature of the thermal exchange control layer is lower than the second write layer, wherein the thermal exchange control layer partially turns the vertical exchange coupling between the first write layer and the second storage layer on and off during a write process and cooling, wherein the partial turn on and off by the thermal exchange control layer suppresses noise.

14. The apparatus of claim 8, wherein magnetization of the second write layer aligns with an external magnetic field at writing temperature of the second write layer, wherein magnetization of the first write layer aligns with the external magnetic field at writing temperature of the first write layer, and wherein magnetization of the second storage layer aligns with the external magnetic field subsequent to the second write layer and the first write layer aligning with the external magnetic field at writing temperature of the second storage layer, and wherein magnetization of the first storage layer aligns with the external magnetic field at writing temperature of the first storage layer subsequent to the first storage layer aligning with the external magnetic field.

15. An apparatus comprising:
a plurality of storage layers; and
a plurality of write layers disposed on the plurality of storage layers, wherein anisotropy field of the plurality of storage layers and the plurality of write layers form an increasing gradient value from an uppermost write layer of the plurality of write layers to a bottommost storage layer of the plurality of storage layers, and wherein a Curie temperature of the plurality of storage layers and the plurality of write layers form a decreasing gradient value from the uppermost write layer of the plurality of write layers to the bottommost storage layer of the plurality of storage layers.

16. The apparatus of claim 15, wherein a material of a storage layer of the plurality of storage layers includes FePtX and a material of another storage layer of the plurality of storage layers includes FePtY, wherein X is different from Y, and wherein X is selected from a group consisting of Cu, Ag, Ni, Ru, Rh, and Mn and wherein Y is selected from a group consisting of Cu, Ag, Ni, Ru, Rh, and Mn.

17. The apparatus of claim 15, wherein a material of a write layer of the plurality of write layers is selected from a group consisting of FePtX, FeCoPtY, FePdX, FeCoPdY, CoPtZ, CoCrXX, and FeCoYY wherein X, Y, Z, XX, and YY is selected from a group consisting of Cu, Ag, Ni, Ru, Rh, and Mn and wherein a material of another write layer of the plurality of write layers is selected from a group consisting of FePtX, FeCoPtY, FePdX, FeCoPdY, CoPtZ, CoCrXX, and FeCoYY wherein X, Y, Z, XX, and YY is selected from a group consisting of Cu, Ag, Ni, Ru, Rh, and Mn.

18. The apparatus of claim 15, wherein a thickness of the plurality of storage layers ranges from 1-15 nm, and wherein a thickness of each write layer of the plurality of write layers ranges from 0.1 to 5 nm.

19. The apparatus of claim 15 further comprising a thermal exchange control layer disposed between the plurality of write layers and the plurality of storage layers, wherein a Curie temperature of the thermal exchange control layer is lower than the Curie temperature of the bottommost storage layer, wherein the thermal exchange control layer partially turns the vertical exchange coupling between the plurality of write layers and the plurality of storage layers on and off during write process and cooling, wherein the partial turn on and off by the thermal exchange control layer suppresses noise.

20. The apparatus of claim 15, wherein a magnetization of the uppermost write layer aligns with an external magnetic field at writing temperature of the uppermost write layer, and wherein a magnetization of subsequent write layers of the plurality of write layers and subsequent storage layers of the plurality of layers align with the external magnetic field at their respective writing temperatures and in order of the increasing gradient value of the anisotropy field.
